(19) United States
(12) Patent Application Publication
(10) Pub. No.: US 2015/0146416 A1
(43) Pub. Date: May 28, 2015

(54) LIGHTING DEVICE

(71) Applicant: RA BRANDS, L.L.C., Madison, NC (US)

(72) Inventors: Jason Timothy Watson, Charlotte, NC (US); Jeremy Eric Losaw, Charlotte, NC (US)

(21) Appl. No.: 14/546,095

(22) Filed: Nov. 18, 2014

Related U.S. Application Data
(60) Provisional application No. 61/908,846, filed on Nov. 26, 2013.

(51) Int. Cl. F21L 4/00; F21V 21/088; F21V 21/08; F21V 5/04

(52) U.S. Cl. CPC F21L 4/00; F21V 5/04; F21V 21/0885; F21V 21/0816; F21Y 2101/02
USPC 362/191

(57) ABSTRACT

This disclosure relates generally to a personal lighting device for use by a person or which can be releasably mounted to a dog collar, and which includes a light component releasably attached to a mount. The light component comprises an upper portion and a lower portion. The upper portion comprises an outer shell with an ergonomic grip and a polished protective lens. The outer shell houses a series of LED lights that can be arranged equidistant from one another. The lower portion comprises a base with locking features for removably attaching the light component to the mount. The mount includes a receptacle that is sized to receive the base of the light component, and a locking mechanism including locking elements that cooperate with the locking features of the light component, and a spring steel flexure to form a spring biased locking mechanism.

### CROSS REFERENCE TO RELATED APPLICATIONS

The present Patent Application is a formalization of previously filed, co-pending U.S. Provisional Patent Application Ser. No. 61/908,846, filed Nov. 26, 2013 by the inventor named in the present Application. This Patent Application claims the benefit of the filing date of the United States Provisional Patent Application cited above according to the statutes and rules governing provisional patent applications, particularly 35 U.S.C. §119(e) and 37 C.F.R. §1.78(a)(3)-(4). The specification and drawings of the Provisional Patent Application referenced above are specifically incorporated herein by reference as if set forth in their entirety.

### FIELD OF DISCLOSURE

The present disclosure generally relates to personal lighting devices, and more specifically, to a personal lighting device having an ergonomic grip and a releasable locking mechanism for detachably mounting the lighting device to a collar or harness, such as a dog collar, or to a clip or other similar mounting device, to provide a personal light source for use in a variety of applications.

### BACKGROUND OF INVENTION

Walking at night or in low lighting conditions can be very hazardous since the ground and/or potential obstructions or other hazards often cannot be seen. For example, even well-traveled paths and sidewalks can have holes, obstructions, or be littered with glass or other sharp objects that could cause injuries, and which could be undetectable in low light or dark conditions. At times of low light, such as at night, it therefore can be desirable to provide a source of artificial light for safety and security. A lighting device that illuminates the ground and surrounding area may provide visibility and safety for both people and animals. There do exist lights that are attached to a collar or harness that can be worn by an animal or person (i.e., mounted on a dog collar or a headlamp harness for people) to provide illumination of an immediate surrounding area and/or enable the wearer to be seen at night. However, despite the simplicity of these devices, many lighting devices currently on the market often are not ergonomically designed and/or are fixedly mounted to or formed as a part of a collar or strap. Other devices that are releasably mountable can be difficult to securely install and/or remove as needed.

Consequently, there exists a need for an easily removable lighting component having an ergonomic grip and an easily detachable but secure locking mechanism, the lighting component being removable without having to remove the animal's collar or the entire lighting device.

### SUMMARY OF DISCLOSURE

In one embodiment, the present disclosure generally relates to a lighting device for mounting along a length of a collar, strap, harness or to an article of clothing of a user. The lighting device generally comprises a mount or base having an attachment portion for attaching the mount to a collar, harness, or clothing, or alternatively can be configured for attachment to surfaces or items having a radius or curved configuration, such as a handlebar, post or other article. The mount further comprises a cavity or receptacle defined therein, with a locking mechanism received within the cavity. In one embodiment, the locking mechanism includes a spring steel flexure and one or more locking elements or locking projections that extend into the cavity. The lighting device further comprises a lighting component that will be received within the cavity of the mount or base in a secure, lockable but easily releasable mounting, and will include a light source such as an LED or similar device.

In one embodiment, the lighting component comprises a housing having an upper portion and a lower portion. An outer shell generally is mounted over the upper portion of the housing and can have a protective lens, having a clear or polished lens section through which the light from the LED passes, and/or a textured lens section for diffusing the light. The outer shell also can be configured with a series of ergonomic features, for example, having a generally triangular, circular, square or other geometric design, and/or a series of indentions or contact areas formed thereabout so as to define ergonomic gripping areas, which contact/gripping areas further can include a series of rubberized pods or grip surfaces. The lower portion of the housing comprises a base portion having a chamber or battery compartment defined therein that is configured to receive one or more batteries and can be sealed with a base cover. The outside wall of the base portion also typically will have one or more complimentary locking features for mating with the locking elements of the mount.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the invention, are incorporated in and constitute a part of this specification, illustrate embodiments of the invention, and together with the detailed description, serve to explain the principles of the invention. No attempt is made to show structural details of the invention in more detail than may be necessary for a fundamental understanding of the invention and the various ways in which it may be practiced. In addition, it will be understood by those skilled in the art that the embodiments of the invention and the various features thereof discussed below are explained in detail with reference to non-limiting embodiments and examples that are described and/or illustrated in the accompanying drawings. It should be noted that the features illustrated in the drawings are not necessarily drawn to scale, and features of one embodiment may be employed with other embodiments as the skilled artisan would recognize, even if not explicitly stated herein. Descriptions of certain components and processing techniques further may be omitted so as to not unnecessarily obscure the embodiments of the invention.

FIG. 1A is a perspective view of one example embodiment of the lighting device, including a light component detachably connected to a mount.

FIG. 1B is an exploded perspective view of the lighting device of FIG. 1A.

FIG. 2 is a cross-sectional view of the light component of FIGS. 1A-1B connected to the mount.

FIGS. 3 and 4 are perspective views of the lighting component of FIGS. 1A-1B.

FIG. 5 is a perspective view of an example embodiment of the mount of FIGS. 1A-1B.

FIG. 6 is a side view of the mount of FIG. 5.

FIGS. 7 and 8 are perspective views of another embodiment of a mount for the lighting device in accordance with the principles of the present invention.

FIG. 9 is a perspective view of still another example embodiment of a color mount for the lighting device in accordance with the principles of the present invention.

FIG. 10 is a cross-sectional view of the collar mount of FIG. 9.

### DETAILED DESCRIPTION OF INVENTION

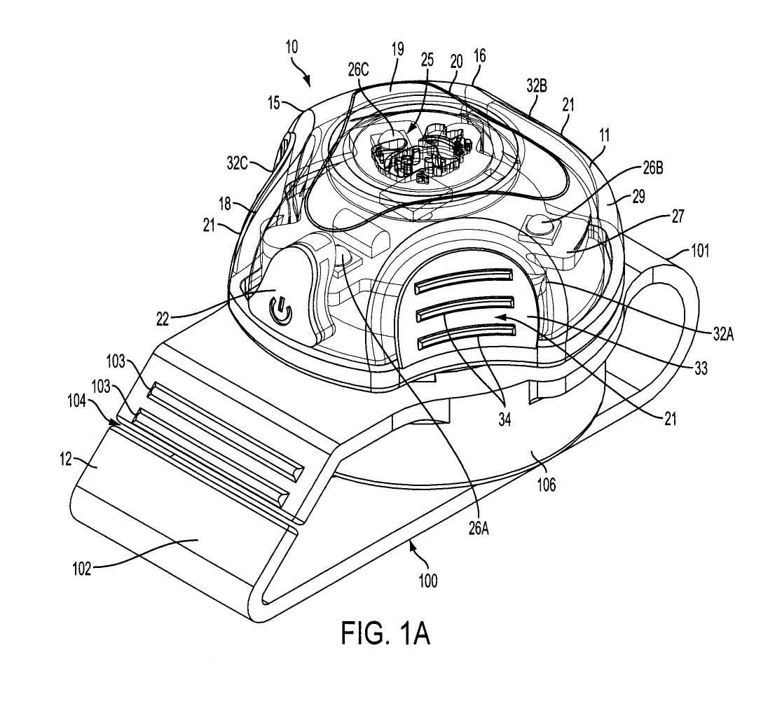

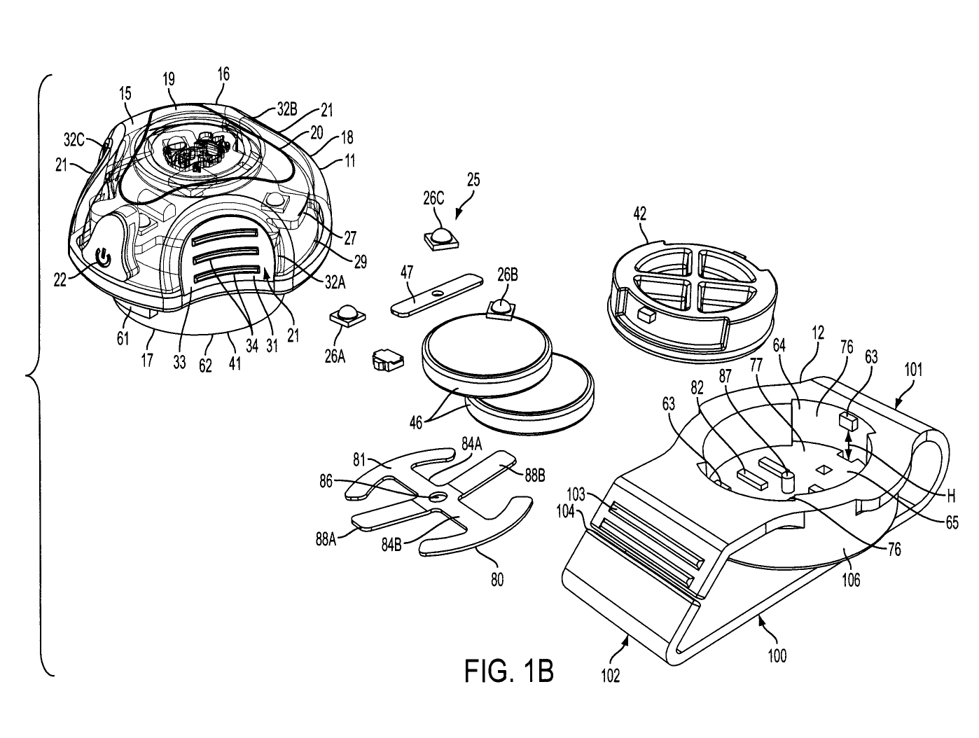

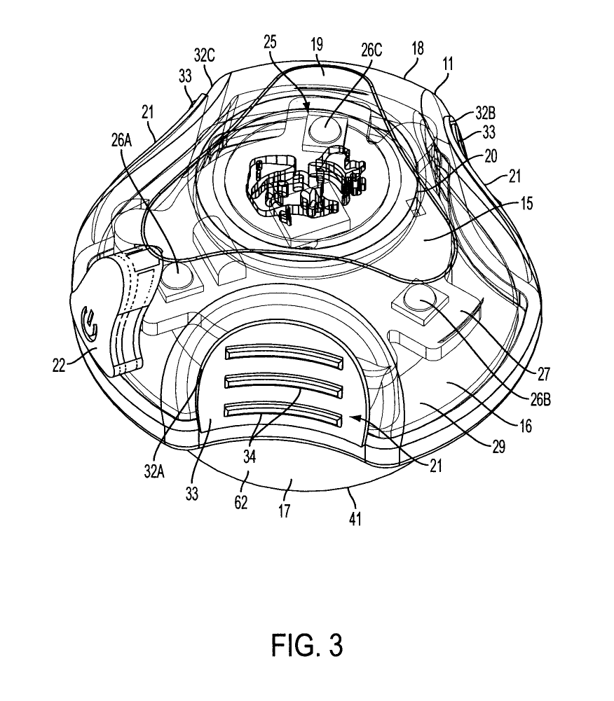

Referring now to the drawings in which like numerals indicate like parts throughout the several views, FIGS. 1A-10 show a personal lighting device 10 with a light component 11 and a mount 12 in accordance with various illustrative embodiments of the present invention. The lighting device 10 may be releasably attached to an animal's collar, leash, harness or to clothing and/or any other location to which the mount 12 is capable of attaching. The lighting device is designed to be lightweight and as unobtrusive as possible to the wearer (i.e., a pet or person) while providing ample illumination capable of dawning light on a desired or focused area for purposes such as visibility, night tracking, and general safety and is further capable of being quickly removed for wider use such as a flashlight, and reattached/mounted in an easy to operate but secure manner.

In one embodiment, as shown in FIGS. 1A-4, the light component 11 of the lighting device 10 comprises an ergonomically designed housing 15, typically formed from a molded plastic or synthetic material, or other similar material, having an upper portion 16 and a base, lower portion or body 17. The upper portion 16 of the housing generally comprises an outer shell 18 with a protective lens portion 19, an ergonomic grip configuration 21 including one or more contact or gripping areas defined about the outer shell, and a power button 22, here shown as located on the side of the outer shell, although it could be placed in other locations and/or other means of activating the lighting device also can be used. The outer shell 18 generally can be integrally formed with the lower portion 17 or can be detachable, for example, being attached to the lower portion by a threaded connection or by snap-fit, with a seal provided therebetween to resist moisture. The outer shell further houses or encloses a light source 25 for the lighting device 10, with the light from the light source showing through the protective lens portion 19.

Various types of light sources 25 can be used, preferably selected to provide high intensity illumination while having a compact size and minimal power requirements. For example, in the present embodiments, a series of LED's 26A-26C can be used, with 3 LED's being shown mounted to a circuit board 27 and arranged approximately equidistant from one another. Alternatively, other configurations of more or less lights of different types and arrangement also can be made without departing from the disclosure. The protective lens 19 covers and protects the light source 25 and can include a polished front or top portion 20 (i.e., generally extending over the LED's) and allow for maximum optical clarity and sight distance. The lens 19 also can have surface features such as a frosted or textured pattern portion 29, for example, along the sides thereof, or otherwise be configured to diffuse or soften the glare from the light source, as desired.

The outer shell further generally will be formed with an easy to grip configuration, for example, having a generally triangular or tri-lobed shape that can generally correspond to the orientation of the 3 LED lights 26A-26C inside the outer shell. Other easy to grip geometric configurations such as square, round, etc. also can be used. The outer shell further can include a series of ergonomic features, here shown as including indentations 32A-32C defining the ergonomic grip configuration 21 of the lighting component 11. By way of example, as illustrated, one or more indentations can be provided, even arranged adjacent one of the LED lights. In one embodiment, the ergonomic grip 21 further can include rubberized portions 33 located within the indentations 32A-32C formed about the outer surface of the outer shell. Each of the ergonomic features further can have a gripping feature 34, for example, grip protrusions, ridges, dots, or other similar features, that can further facilitate gripping of the outer shell 18 that aid in frictionally gripping the lighting component 11. The gripping features may comprise more or less grip protrusions, or none, without departing from the disclosure. The indentations 32A-32C and their gripping features can be designed for optimal grip by the thumb, index, and middle fingers of a user's hand, thus reducing stress on the fingers and hands when gripped and turned to facilitate easy, one-handed locking and release. Other ergonomic features, such as outwardly projecting tabs, flattened areas, and/or additional features other than indented or recessed areas, which facilitate gripping of the light component also can be used.

When the light component is actuated by the power button 22, the light component turns on and the LEDs 26A-26C emit light. The polished portion 20 directs the primary illumination of the light source over a desired area, and the use of a textured portion 29 along the sides or other areas of the lens can help diffuse the light emitted by the LEDs, creating a glowing effect that is capable of dawning light on large areas. The light component 11 may also be configured to emit flashes or strobes of light, and/or could be provided with a shutter to focus the light to a directed or more defined area.

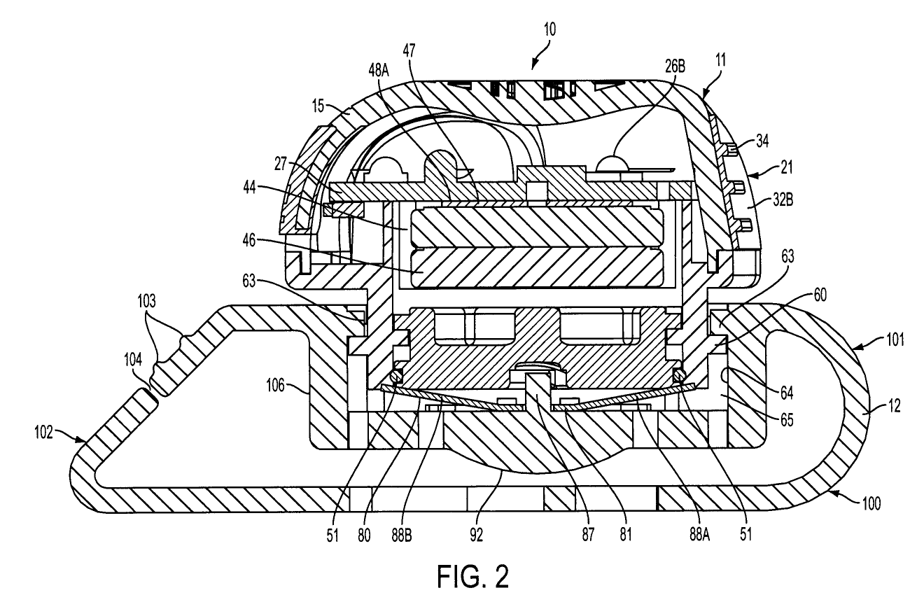

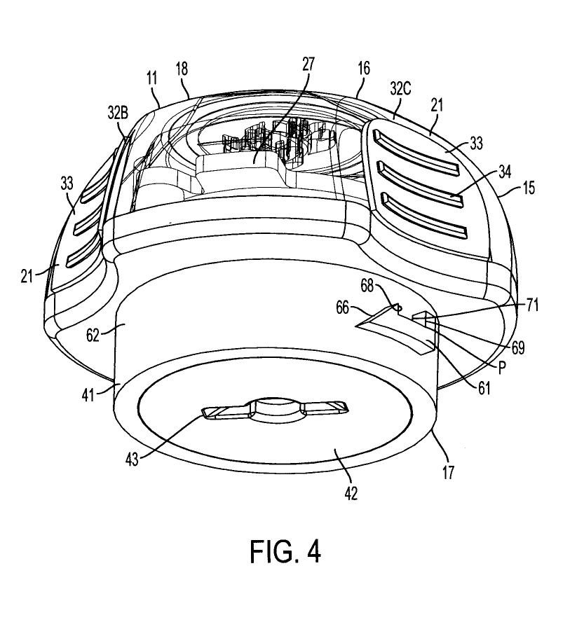

FIG. 4 illustrates the lower portion 17 of the light component 11. The lower portion comprises a substantially circular base 41 with a base cover 42 located at the bottom of the base portion. The base cover 42 generally can be threadably or otherwise attached to the base 41, and further can have a slot 43 in which a coin or screwdriver can be inserted to turn and remove the base cover to access a cavity or compartment 44 inside of the base. As illustrated in FIG. 2, this cavity 44 defines a compartment that may house a power source, in one embodiment including a series of batteries such as one or two CR2032 3V lithium ion batteries 46. Other types and numbers of batteries such as alkaline batteries, silver oxide batteries, rechargeable batteries (i.e., nickel metal hydride), or any other type of suitable battery may be used without departing from the disclosure. A terminal/lead 47 (FIGS. 1B and 2) is located at the top 48A of the cavity of the base 41, while the base cover is applied over the open bottom of the cavity. The base cover may be shaped or arranged differently and may be fastened by screws, a clip mechanism or other fastening means without departing from the disclosure.

As shown in FIG. 2, in one embodiment, the cavity 44 of the base and the base cover 42 may be sealed with an O-ring 51. The O-ring 51 generally abuts the lower end or rim of the base cover, forming a seal for preventing moisture and other foreign material from entering the inside of the cavity. The O-ring 51 may be made from pliable material such as rubber, polyethylene, nitrile, and other similar materials.

As illustrated in FIGS. 1B-2, the light component 11 is adapted to be easily and securely mounted and removed from the mount 12, typically by one hand, but is protected against inadvertent removal or dislodging of the lighting component unless the locking mechanism 60 of the lighting device 10 is affirmatively disengaged. In one embodiment, the locking mechanism 60 comprises push and twist locking mechanism, with one or more locking features 61 located about the side wall 62 of the base 41 of the lighting component 11, adapted to cooperatively engage corresponding locking elements 63 formed/located along an inner side wall 64 of a receptacle or cavity 65 formed in the mount 12. While 2 sets of cooperating locking features/elements are shown, it will be understood that more or fewer locking features/elements can be provided.

The locking features 61 of the base 41 each can be formed as inwardly directed projections having a ramp mating feature 66 with a slanted edge for easy engagement with the corresponding locking elements 63 of the mount 12. Each locking feature also can have a front stop 68 and a back stop 69. The front stop 68 and the back stop 69 of each locking feature form an engagement recess or indentation 71 that matingly receives a corresponding locking element of the mount. The back stop 69 thus prevents a captured locking element from turning past a point “P” (FIG. 4) when the light component is secured to the mount, while the front stop 68 engages the captured locking element 63 and prevents the light component from inadvertently being turned so as to become disengaged from the mount 12. As illustrated in FIG. 4, each locking element 63 of the mount 12 is designed to be locked within an engagement indentation 71 of a corresponding locking feature when the light component 11 is turned in a first direction (i.e., clockwise), and to unlock from the engagement indentation 71 when the light component 11 is pushed in and twisted in a second direction (i.e., counter-clockwise).

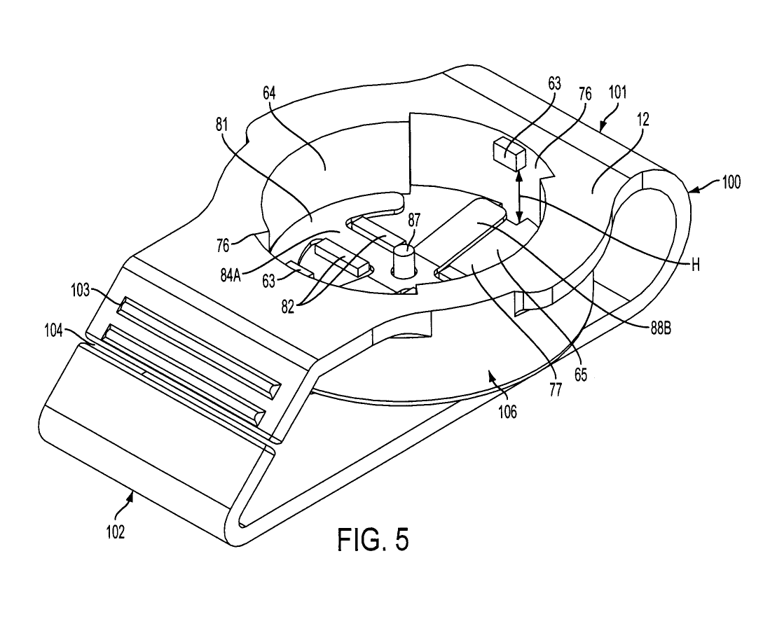

FIGS. 1A-1B, 5 and 6 illustrate one example embodiment of the mount 12. As noted, the mount 12 will have a hollow receptacle or cavity 65 sized and configured for matingly receiving the light component 11 in a seated engagement therein. As shown in FIGS. 1B and 5, the cavity 65 generally has one or more cutout portions 76, each having a male locking key/projection or locking element 63 that extends into the cavity 65 and which is configured to mate with the locking features 61 of the light component 11. The locking elements 63 are positioned at a distance “H” (FIGS. 1B and 5) from the bottom 77 of the cavity 65, and while the locking elements 63 are shown in the present embodiment as substantially rectangular they could be square, trapezoidal, or any other shape with at least two edges that can engage the front stop 68 and back stop 69 of one of the locking features 61 of the light component 11.

The locking mechanism 60 further generally includes a biasing member 80, such as a metal (i.e., steel) or other material spring flexure 81 that is received within the receptacle and applies a bearing/biasing force against the base of the light component. As shown in FIGS. 1B and 5, the bottom of the cavity 65 can be formed with alignment features 82, such as grooves, slots, protrusions or other features for aligning the spring flexure 81. The spring flexure 81, in one embodiment can have generally I or H-shaped body with legs or arms 84A/84B that fit into the alignment features 82, and an opening 86 located approximately in its center that mates with a guide pin or post 87. The steel spring flexure 81 also can have two or more prongs 88A/88B that extend or are angled upward from the bottom of the receptacle and engage the bottom of the base 41 of the light component 11. The prongs 88A/88B act as a spring to apply an upwardly biased pressure or bearing force to the light component 11 for securing the locking elements 63 of the mount 12 in the push and twist locking features 61 of the light component 11 in engagement.

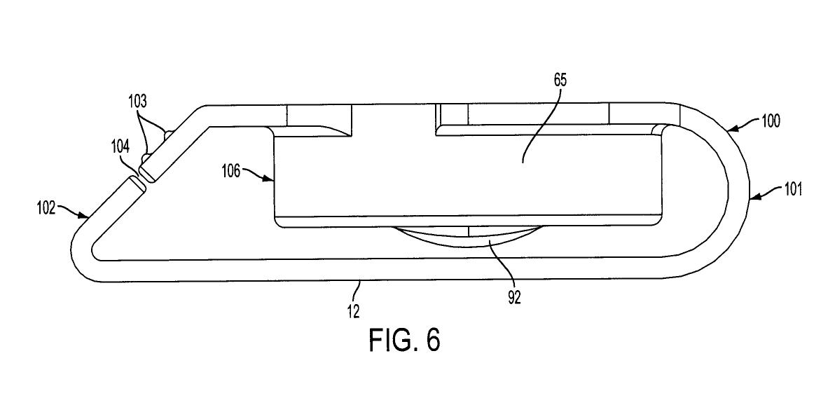

The mount 12 further will include an attachment portion that can be formed in various configurations for mounting to a collar, strap, harness, clothing or a variety of other, differing applications as desired. For example, in one embodiment shown in FIGS. 1A-2, 5 and 6, the attachment portion 100 of the mount 12 can be formed in a “clip” structure, having a first or forward side portion 101 and a relatively flat or oblique rear or second side portion 102 with grip protrusions 103 and a slit or opening 104 to enable the mount to be “clipped” or mounted onto a collar, strap, clothing, etc. As illustrated in FIGS. 5-6, this clip type attachment portion 100 of the mount 12 also will have a body section 106 formed along the forward portion 101, and which has a construction of the mount 12 as discussed, including the receptacle 65 and locking elements 63 as described above. The first and second portion may be rubberized to provide greater frictional resistance, thus further improving the ability to grab the strap or collar, and an additional raised bearing projection, protrusion or bump 92 can be provided along a rear side of the body 106, as shown in FIG. 6, to help maintain engagement between the clip and a supporting surface or clothing.

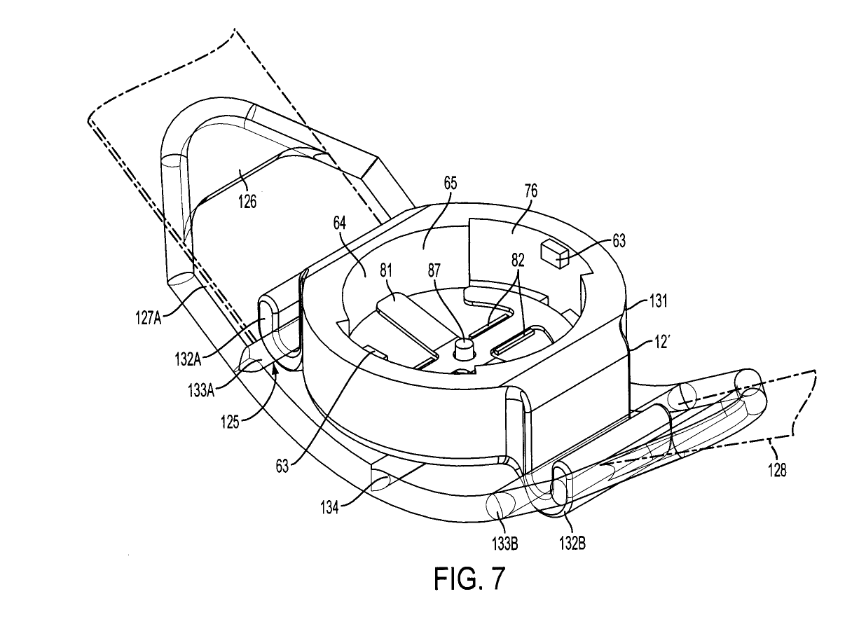

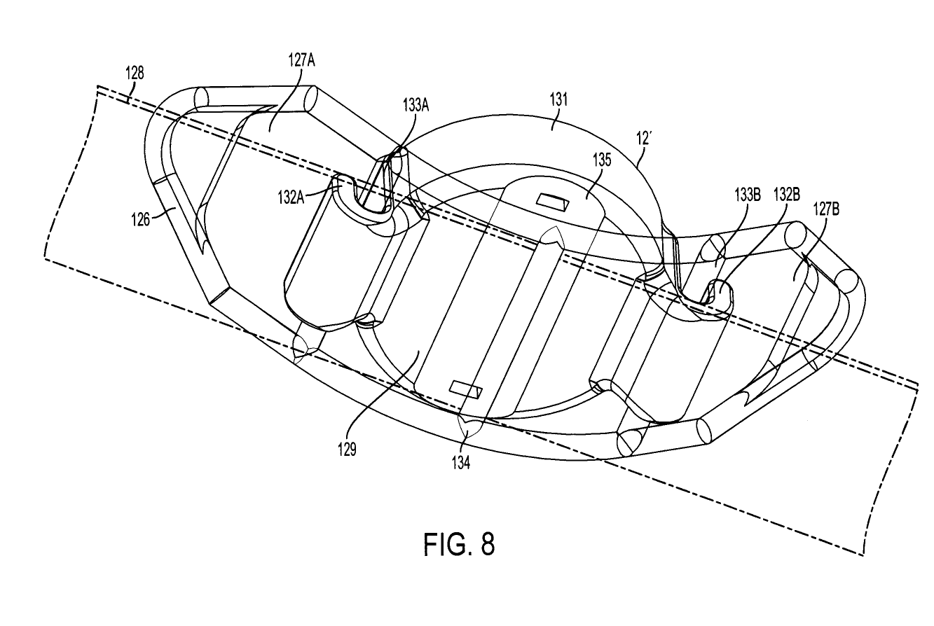

FIGS. 7 and 8 illustrate an alternative embodiment of the attachment portion 125 for mounting a light component mount 12′ of the lighting device 10. The light component mount 12′ is configured for mounting to a strap, band, etc., and further can be adapted to mount the light component to various other items, such as handlebars for a bicycle or motorcycle, to a seat post, paddle, and/or other, similar articles or items, including items having a radiused configuration or surface. As shown in FIG. 7, in this embodiment, the attachment portion 125 comprises a mounting frame 126 having open areas 127A/B for attaching the mount to a surface or article, for example, to a band or strap 128 (shown by phantom lines) and a central seating area 129 wherein the body 131 of a light component mount 12′ is received. The structure and locking mechanism of this embodiment of the light component mount generally is the same as described above. Accordingly, similar or identical features of the embodiments are provided with like reference numbers. The attachment portion further can include U-shaped hooked engaging members 132A/B projecting from a bottom edge of the body 131, which mate with cross members 133A/B of the frame 126, and being held in locked engagement by a friction fit. The body of the light component mount 12′ further typically has a bottom that comprises a hemispherical cutout 135 that may be rubberized and configured to mate with a generally circular collar, strap, frame, or the like. The third cross member 134 positioned between the cross members 133A/B provides support to and helps prevent the light component mount from twisting or detaching from the frame 126, and which can also provide a further means for attaching the frame to the collar or strap. The frame 126 also typically will have rounded edges and may be rubberized to provide better grip.

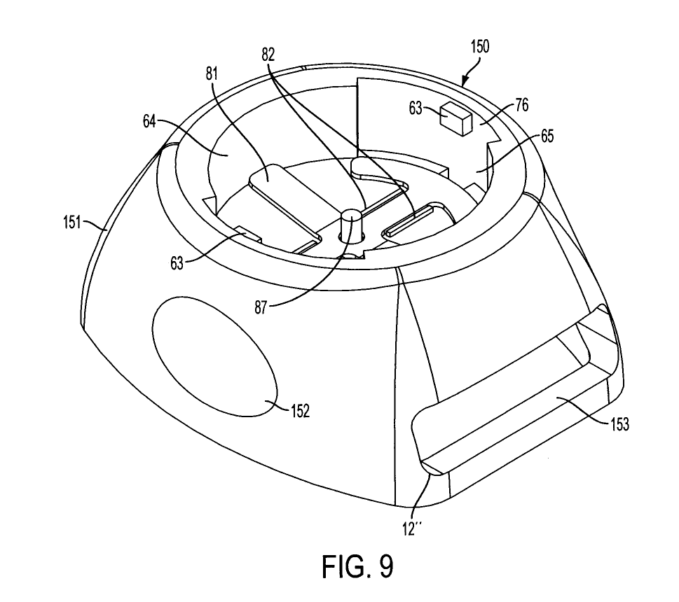

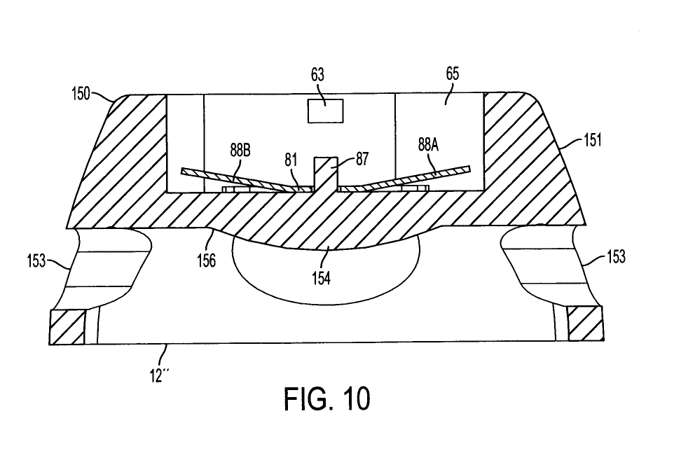

FIGS. 9 and 10 illustrate still another embodiment of the lighting device 10 having a collar mount 12″ configured with an integrated attachment portion 150 that can be adapted for mounting to a pet collar or harness. The locking features 63 of the collar mount 12″ are the same as for the mounts 12 and 12′ described above with reference to FIGS. 1A-6 and 7-8, respectively. Accordingly, similar or identical features of the embodiments are provided with like reference numbers. The attachment portion 150 (FIGS. 9-10) of the collar mount 12″ generally comprises a body 151 having indentations 152 in the side of the collar mount for the finger grip, and slots 153 on opposite sides thereon for attaching the collar mount to the dog collar. The slots 152 are substantially rectangular however; each slot may be circular, oval, or any other shape which allows for the collar, harness or strap to enter without departing from the disclosure. As further illustrated in FIG. 10, in one embodiment, the collar mount 12″ can have a raised area or projection 154 along a rear side surface of the collar mount for providing further tension on the collar to for better grip reducing the collar mount movement. The bottom surface 156 of the collar mount 12″ further can be configured with a radiused or recessed area adapted to receive and seat the collar mount 12″ on a curved or radiused surface, such as for mounting to bicycle/motorcycle/ATV handlebars, mounting to a post or handle, to a paddle, along a railing such as for a boat, or to various other items.

In one exemplary method of use of the lighting device 10, the mount generally will be attached to an article, such as a pet collar, strap, harness, or an article of clothing, for example, or to a surface such as handlebars, rail, etc., typically by clipping, threading or otherwise releasably attaching the mount to the strap, etc. Alternatively, the mount can be more permanently affixed to a surface such as a handle, post, rail, etc. . . . , by adhesives, fasteners, or other, similar means. With the mount in place, while holding the light component in the ergonomic grip 21 with thumb, index, and middle fingers; the user can simply insert the light component 11 into the receptacle of the mount 12/12′, 12″, rotating the light component 11 to align the locking features 61 of the light component 11 with cutout portion 76 of the mount. The user then can urge or push the light component 11 fully into the receptacle of the mount and turn the light component clockwise until the one or more of the locking elements 63 of the mount hit a back stop 69 of their engaged locking features, preventing the light component for continuing to turn. The user then releases the light component, which is biased slightly forwardly by the biasing member 80 (FIG. 1B), to place the locking elements within the engagement recesses 71 of the locking features, with the light component thereafter being maintained in a biased, locked condition.

To remove the light component from the collar mount, the user will first push the light component 11 inward such that the locking element(s) 63 of the mount are moved to a position so as to be moved out of the recesses 71 of the locking features and to a location at a clearance with respect to the front stops 68 of their engaged locking features 61. The user then simply turns the light component 11 counter-clockwise until the locking elements 63 are moved past/out of engagement with the locking features 61. The light component is then free to be removed from the mount.

The foregoing description generally illustrates and describes various embodiments of the present invention. It will, however, be understood by those skilled in the art that various changes and modifications can be made to the above-discussed construction of the present invention without departing from the spirit and scope of the invention as disclosed herein, and that it is intended that all matter contained in the above description or shown in the accompanying drawings shall be interpreted as being illustrative, and not to be taken in a limiting sense. Furthermore, the scope of the present disclosure shall be construed to cover various modifications, combinations, additions, alterations, etc., above and to the above-described embodiments, which shall be considered to be within the scope of the present invention. Accordingly, various features and characteristics of the present invention as discussed herein may be selectively interchanged and applied to other illustrated and non-illustrated embodiments of the invention, and numerous variations, modifications, and additions further can be made thereto without departing from the spirit and scope of the present invention as set forth in the appended claims.

What is claimed is:

1. A personal lighting device, comprising:
a mount comprising:
an attachment portion configured for connection to a strap, collar, clip, or clothing;
a receptacle defined within a forward surface of the mount and having a locking mechanism therein; and
a light component removably mounted within the receptacle of the mount and comprising:
a housing,
a light source mounted on a forward portion of the housing,
a series of ergonomic features formed at spaced locations about the housing to facilitate gripping of the light component, and
at least one locking feature formed about the housing and configured to engage the locking mechanism within the receptacle of the mount as the light component is seated within the receptacle of the mount for releasably attaching the light component to the mount.

2. The personal lighting device of claim 1, wherein the light source comprises at least one LED.

3. The personal lighting device of claim 1, wherein the light component further comprises an outer shell defining a lens through which light from the light source passes.

4. The personal lighting device of claim 3, wherein the lens includes a surface feature for diffusing light from the light source.

5. The personal lighting device of claim 1, wherein the housing of the light component further comprises a rear portion having a cavity defined therein, the cavity configured to receive a battery.

6. The personal lighting device of claim 5, wherein the cavity comprises an open end, and the housing further comprises a base cover configured to releasably engage and enclose the open end of the cavity.

7. The personal lighting device of claim 1, wherein the locking mechanism of the mount comprises a spring flexure element mounted within the receptacle and having a forward projecting biasing portion adapted to apply a bearing force against the light component when the light component is received within the receptacle; and at least a first locking element located along a side wall of the cavity, the first locking element configured to engage the at least one locking feature formed along the housing of the light component to secure the light component within the receptacle of the mount.

8. The personal lighting device of claim 1, further comprising an elongated frame defining a central seating area along which the mount is received, a series of cross members adjacent the seating area of the frame and adapted to receive a strap or collar therebetween for attaching the mount to the strap or collar; and wherein the attachment portion of the mount further comprises a pair of engaging members projecting from opposite sides of the mount and which engage the cross members for securing the mount to the frame.

9. The personal lighting device of claim 1, wherein the attachment portion of the mount comprises a clip formed about a rear portion of the mount.

10. The personal lighting device of claim 9, further comprising a bearing projection along a rear side of the mount.

11. The personal lighting device of claim 1, wherein the attachment portion of the mount further comprises a pair of slots adapted to receive a strap, harness or collar therethrough.

12. The personal lighting device of claim 1, wherein the series of ergonomic features include at least one indentation formed about the housing, each of the at least one indentations include a rubberized portion having one or more projections forming a gripping feature.

13. The personal lighting device of claim 12, wherein each of the at least one indentations include a rubberized portion having one or more projections forming a gripping feature.

14. A lighting device configured to be removably mounted to a strap, collar, clip, clothing or other article, comprising:
a light component including a housing having a body in which a light source and a power source are received, an outer shell detachably mounted to the body of the housing, covering the light source, and including a series of ergonomic features to facilitate gripping and manipulation of the light component, and a locking feature formed about the body of the housing; and
a mount including an attachment portion configured to engage and releasably attach to the strap, collar, clip, clothing or other article, and a locking mechanism configured to matingly engage with the locking feature of the light component for releasably mounting the light component to the mount.

15. The lighting device of claim 14, wherein the locking mechanism of the mount comprises a spring flexure element mounted within the receptacle and having a forward projecting biasing portion adapted to apply a bearing force against the light component when the light component is received within the receptacle; and at least a first locking element located along a side wall of the cavity, the first locking element configured to engage the at least one locking feature formed along the housing of the light component to secure the light component within the receptacle of the mount.

16. The lighting device of claim 7, wherein the at least one locking feature formed along the housing includes a ramp mating feature with a slanted edge for engaging the first locking element located along a side wall of the cavity.

17. The lighting device of claim 14, wherein the light source comprises at least one LED.

18. The lighting device of claim 14, wherein the attachment portion of the mount comprises a clip formed about a rear portion of the mount.

19. The lighting device of claim 14, wherein the outer shell defines a lens through which light from the light source passes, and wherein the lens includes a surface feature for diffusing light from the light source.
